(19) United States
(12) Patent Application Publication
(10) Pub. No.: US 2020/0207064 A1
(43) Pub. Date: Jul. 2, 2020

(54) MULTI-PANE GLAZING FOR IMPROVED SOUND ATTENUATION

(71) Applicant: Pittsburgh Glass Works, LLC, Pittsburgh, PA (US)

(72) Inventors: Michael ULIZIO, Pittsburgh, PA (US); DeWitt LAMPMAN, Allison Park, PA (US)

(73) Assignee: Pittsburgh Glass Works, LLC, Pittsburgh, PA (US)

(21) Appl. No.: 16/724,531

(22) Filed: Dec. 23, 2019

Related U.S. Application Data
(60) Provisional application No. 62/785,858, filed on Dec. 28, 2018.

(51) Int. Cl. B32B 17/10

(52) U.S. Cl. CPC B32B 17/10137; B32B 17/10045; B32B 17/10119; B32B 17/10761; B32B 2605/006; B32B 2307/412; B32B 2307/102; B32B 2307/514; B32B 2329/06

(57) ABSTRACT

A process for making a multi-transparency glazing that has similar nominal weight as a standard two-transparency laminate glazing that has been determined to increase acoustic attenuation over coincidence frequencies of monolithic and two-transparency design using multi-stage damping to further convert vibrational energy to heat.

### RELATED APPLICATIONS

This application claims priority to U.S. Provisional Patent Application No. 62/785,858 filed Dec. 28, 2018, the entirety of which is incorporated by reference herein.

### BACKGROUND OF THE INVENTION

### Field of the Invention

The presently disclosed invention is related to window glazings that are suitable for use in automotive applications.

### Description of the Prior Art

For many years, automotive vehicles have employed window glazings in which a heating process is used to bond two sheets of glass or other transparent material with a sheet of light-transmissive polymer material that is located between the two transparent layers. Typically, the glass is float glass although in some cases chemically-tempered glass has also been used. An example is shown in U.S. Patent Application Publication 2012/0094084. The polymer material has been generally selected from a group of materials that includes polyvinyl butyral (PVB) and ethylene vinyl acetate (EVA).

More recently, there has been increasing emphasis on the mileage efficiency of automotive vehicles. That emphasis has been addressed, in part, through reduction of vehicle weight. With respect to automotive glazings, such weight reduction has focused on decreasing the thickness of the glazing laminate.

The reduction of the thickness of automotive glazing laminates requires attention to a number of factors. Some of these factors create competing variables in glazing designs. Examples of such competing variables include mechanical rigidity and stability, optical distortion, abrasion resistance, light transmissivity, and cost as well as others. All such considerations must be reasonably accommodated in a commercially acceptable automotive glazing.

In the prior art, transparencies of glass or other materials used in vehicular glazing laminates were generally of the same thickness. However, in some cases the glazing weight has been decreased while still meeting certain performance requirements by reducing the thickness of only one of the glass plies or to reduce the thickness of one glass ply more than the other. A glazing laminate in which the thickness of one glass ply is less than the thickness of another glass ply is referred to herein as an “asymmetric glazing.” In other cases, the glazing weight has been reduced by reducing the thickness of both transparencies by an equivalent amount such that both transparencies have the same nominal thickness. A glazing laminate in which the glass layers have the same nominal thickness is referred to herein as a “symmetric glazing.”

With respect to automotive glazings, the greatest potential benefit for weight reduction is with respect to windshields because they represent the largest glazed area in most vehicles. However, advantages for weight reduction are also supported through the use of lighter glazings throughout a vehicle, including glazings other than windshields. With regard to such other, non-windshield glazings, competing considerations of mechanical strength and stone impact resistance are less significant because they generally do not have forward looking orientation in the vehicle. For that reason, cost and other considerations sometimes support use of symmetric glazings—particularly for automotive sidelight and backlight glazings. In the prior art, sound attenuation has been an important consideration in glazing design. It has been known that glazings with higher mass (e.g. greater thickness) tend to absorb more sound. However, the increasing emphasis on vehicle weight reduction and a consequent tendency toward lighter (i.e. less massive) glazings has allowed for a compromise of decreasing sound attenuation in lighter-weight automotive glazings.

Laminated glazings are known to have a “constrained layer effect” that enables laminated glazings to absorb more sound than equivalent weights of monolithic glass. More specifically, the “constrained layer effect” refers to sound damping by an interlayer that is constrained between two transparencies. The interlayer is comprised of a viscoelastic polymer such as PVB. Sound waves that impact the outer surface of the outer transparency propagate through the outer transparency to the interlayer where they deform the interlayer in a way that creates shear forces therein. Part of the energy of the interlayer shear forces is converted to heat. That energy conversion reduces the mechanical energy of vibrations that are transferred from the interlayer to the inner transparency and, ultimately, the passenger compartment of the vehicle. Thus, the conversion of sound energy to heat results in lower acoustical energy that is transmitted from the glazing to the passenger compartment. In some cases, interlayers with enhanced acoustical properties have been developed. Laminated glazings with such interlayers absorb more sound than standard polymer interlayers.

The importance of sound attenuation in vehicular glazings has warranted further attempts to identify and optimize sound attenuation characteristics in automotive glazings that are capable of supporting glazing design choices that are more fully informed and efficiently implemented.

### SUMMARY OF THE INVENTION

In accordance with the disclosed invention, multi-transparency laminate glazings are constructed with three or more transparencies that are bonded together in a laminate stack by intervening polymer layers. The multi-transparency laminate glazing may have all transparent layers the same thickness or layers of various thicknesses. The multi-transparency laminate glazing affords greater sound attenuation in the coincidence dip than is found in two-transparency laminate glazings. The transparencies may have thicknesses such that the per unit weight of the multi-transparency laminate glazings is comparable to (i.e. 10% greater or less) that of the per unit weight of two-transparency glazings that demonstrate a coincidence dip.

Other advantages and features of the presently disclosed invention will become apparent to those skilled in the pertinent art as a presently preferred embodiment of the disclosed invention proceeds.

### BRIEF DESCRIPTION OF THE DRAWINGS

A presently preferred embodiment of the disclosed invention is shown and described in connection with the accompanying drawings in which:

FIG. 1 is a top perspective view of a section of a symmetric multi-panel glazing with portions thereof broken away to better disclose the structure thereof;

FIG. 2 is a top perspective view of a section of an asymmetric multi-panel glazing with portions thereof broken away to better disclose the structure thereof;

FIG. 3 is a graph representing the sound transmission loss of several glazing laminates as a function of frequency of the incident sound;

FIG. 4 is a graph representing the sound transmission loss of a 2.1/2.1 AC-PVB laminate and a 1.4/1.4/1.4 laminate as a function of frequency of the incident sound;

FIG. 5 is a graph representing the sound transmission loss of a 2.1/2.1 AC-PVB laminate and a 1.4/1.4/1.4 laminate as a function of frequency of the incident sound;

FIG. 6 is a graph representing the sound transmission loss of a 2.1/2.1 AC-PVB laminate and a 1.4/1.4/1.4 laminate as a function of frequency of the incident sound;

FIG. 7 is a graph representing the sound transmission loss of a 2.1/2.1 AC-PVB laminate and a 1.2/1.2/1.2 laminate as a function of frequency of the incident sound;

FIG. 8 is a graph representing the sound transmission loss of a 2.1/2.1 AC-PVB laminate and a 1.2/1.2/1.2 laminate as a function of frequency of the incident sound;

FIG. 9 is a graph representing the sound transmission loss of a 2.1/2.1 AC-PVB laminate and a 1.2/1.2/1.2 laminate as a function of frequency of the incident sound;

FIG. 10 is a graph representing the sound transmission loss of a 2.1/2.1 AC-PVB laminate and a 0.7/0.7/0.7 laminate as a function of frequency of the incident sound;

FIG. 11 is a graph representing the sound transmission loss of a 2.1/2.1 AC-PVB laminate and a 0.7/0.7/0.7 laminate as a function of frequency of the incident sound;

FIG. 12 is a graph representing the sound transmission loss of a 2.1/2.1 AC-PVB laminate and a 0.7/0.7/0.7 laminate as a function of frequency of the incident sound;

FIG. 13 is a graphic demonstration of improved sound attenuation qualities as compared to two-transparency glazings; and

FIG. 14 displays the sound attenuation of a symmetrical multi-transparency glazing such as shown in FIG. 1 in comparison to a two-transparency glazing.

### DESCRIPTION OF A PRESENTLY PREFERRED EMBODIMENT

Significant aspects of sound attenuation in symmetric and asymmetric automotive glazings with two glass plies are discussed in “Practical Design Considerations for Lightweight Windshield Application” published Feb. 28, 2017 and filed by Applicant as U.S. Provisional Application 62/448,657 which document is hereby specifically incorporated herein by reference in its entirety.

The presently disclosed invention concerns sound attenuation in connection with multi-panel symmetrical glazings—particularly for vehicular use. The emphasis on weight reduction of automotive vehicles has tended to support the use of glazings with lower thicknesses. However, weight reduction in glazing laminates sometimes results in substantial and unexpected increases in sound transmissivity.

Some examples of the presently disclosed invention, when compared to prior glazing laminates of comparable weight, provide glazing laminates with improved acoustical performance. Other examples of the presently disclosed invention, when compared to prior glazing laminates of greater weight, provide glazing laminates of comparable and even improved acoustical performance. For example, one prior glazing laminate is constructed of two plies of float glass, each having a nominal thickness of 2.1 mm that are laminated together by an interlayer of PVB with 0.76 mm thickness. Another example of a prior glazing laminate is constructed of two plies of float glass, each having a nominal thickness of 2.1 mm that are laminated together by an interlayer of acoustic PVB with 0.76 mm thickness. In still other examples, the layers of 1.4 mm glass can be heat strengthened by a thermal tempering process. In cases where transparencies are less than 1.4 mm, such as 0.7 mm glass, such thinner transparencies generally use more-costly aluminosilicate glass (as opposed to soda-lime silicate glass that is generally used for 1.4 mm transparencies) and is strengthened through an ion-exchange process rather than thermal tempering. The use of such source material and processing steps frequently result in significantly higher material and manufacturing costs.

In accordance with the disclosed invention, a glazing laminate includes a multiple transparency glazing having at least three transparency plies that are bonded together with two or more interlayers. The individual transparency plies of the multiple transparency glazing have a thickness that is less than the thickness of transparency layers of prior glazing laminates such that the weight of the multiple transparency glazing is substantially equal to or less than the weight of prior two-transparency glazings. At the same time, the multi-transparency glazings in accordance with the presently disclosed invention afford improved sound attenuation features. Namely, multi-transparency glazings that have greater sound attenuation than two-transparency glazings of the same per unit weight and multi-transparency glazings that have a lower per unit weight than two-transparency glazings afford the same or greater degree of sound attenuation.

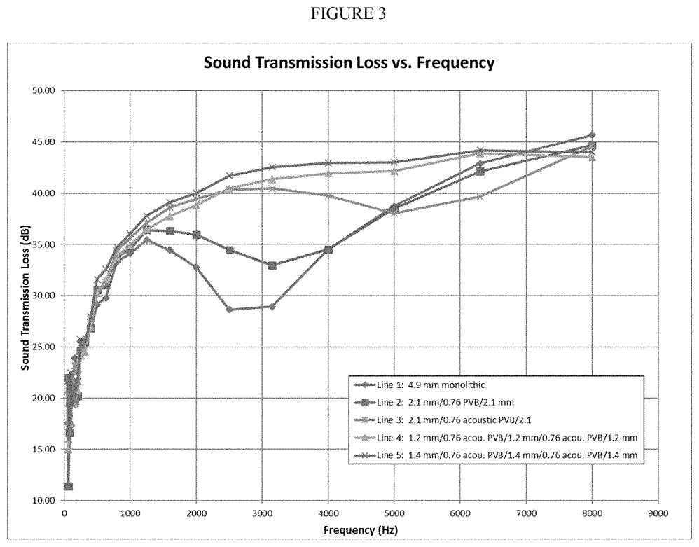

Examples of glazing laminates described above are shown in FIG. 3 below. FIG. 3 describes the sound transmission loss of several glazing laminates as a function of frequency of the sound. Line 1 in FIG. 3 shows sound attenuation of a monolithic transparency with a thickness of 4.9 mm. This data exhibits a pronounced dip in sound attenuation in the frequency range of about 1,500 Hz.-5,000 Hz. The 1,500-5,000 Hz. frequency range covers the frequency range within the hearing of most humans. Accordingly, the loss of sound attenuation in this range can be particularly problematic for vehicle glazings.

Line 2 in FIG. 3 represents sound attenuation of a laminated glazing such as known in the prior art. It is made of two transparency plies that each have a thickness of 2.1 mm and that are bonded together in a lamination process by a layer of PVB having a thickness of 0.76 mm. Similar to Line 1, Line 2 shows that this two-transparency laminate also exhibits a decrease of sound attenuation over the same 1,500-5,000 Hz. range as the monolithic transparency of Line 1.

Line 3 in FIG. 3 also represents sound attenuation of a two-transparency laminate. Like the laminate of Line 2, the laminate of line 3 has two 2.1 mm transparencies that are bonded together in a lamination process by a layer of PVB. However, the Line 3 laminate differs from the Line 2 laminate in that the PVB is an acoustic PVB. The graph of Line 3 shows that the acoustic PVB has improved sound attenuation in the 1,500-5,000 Hz. range as compared to the two-transparency laminate of line 2.

Examples of the presently disclosed invention are displayed in the multi-layer transparency laminates that are shown in line 4 and line 5 of FIG. 3. The multi-layer transparency laminate of Line 4 is made of three transparencies with each layer having a thickness of 1.2 mm. Each transparency layer is bonded to the adjacent transparency layer by a 0.76 acoustic PVB layer. Similarly, the multi-layer transparency laminate of Line 5 is made of three transparencies with each layer having a thickness of 1.4 mm. Each transparency layer is bonded to the adjacent transparency layer by a 0.76 acoustic PVB layer. In comparison to the two-transparency laminates of Lines 2 and 3, Lines 4 and 5 show significantly improved sound attenuation for both multi-layer transparency laminates over the entire range of 1,500-5,000 Hz. and above 5,000 Hz. to approximately 7,000 Hz.

While affording improved sound attenuation features, the presently disclosed multi-transparency laminates also address the weight concerns for vehicle glazings. Table 1 below shows the calculated weights of examples of two-layer transparencies and multi-layer transparencies, including those that are depicted in FIG. 3 below.

TABLE 1
Table 1

| | Weight/Ft2 | | Weight Versus Baseline |
|---|---|---|---|
| Laminate Description | (Kg/Ft2) | (Lb/Ft2) | (%) |
| 2.1 mm/0.76 mmPVB/2.1 mm Float Glass - BASELINE | 1.05 | 2.32 | BASELINE |
| 1.2 mm/0.76 mmPVB/1.2 mm/0.76 mm/PVB/1.2 mm Float Glass | 0.99 | 2.18 | −6.08% |
| 1.4 mm/0.76 mmPVB/1.4 mm/0.76 mmPVB/1.4 mm Float Glass | 1.13 | 2.48 | 7.18% |

| | Base Weight | New weight | Difference | Weight diff. @ 5 |
|---|---|---|---|---|
| Construction | (lbs./ft.²) | (lbs./ft.²) | (%) | Sq. Ft. |
| 2.1/2.1 acoustic PVB vs. 1.4/1.4/1.4 0.38 PVB | 2.316 | 2.317 | 0.04% | 0.005 |
| 2.1/2.1 acoustic PVB vs. 1.4/1.4/1.4 0.76 PVB | 2.316 | 2.482 | 7.17% | 0.83 |
| 2.1/2.1 acoustic PVB vs. 1.4/1.4/1.4 0.76 AC-PVB | 2.316 | 2.481 | 7.12% | 0.825 |
| 2.1/2.1 acoustic PVB vs. 1.2/1.2/1.2 0.38 PVB | 2.316 | 2.009 | −13.26% | −1.535 |
| 2.1/2.1 acoustic PVB vs. 1.2/1.2/1.2 0.76 PVB | 2.316 | 2.175 | −6.09% | −0.705 |
| 2.1/2.1 acoustic PVB vs. 1.2/1.2/1.2 .076 AC-PVB | 2.316 | 2.173 | −6.17% | −0.715 |
| 2.1/2.1 acoustic PVB vs. 0.7/0.7/0.7 0.38 PVB | 2.316 | 1.215 | −47.54% | −5.505 |
| 2.1/2.1 acoustic PVB vs. 0.7/0.7/0.7 0.76 PVB | 2.316 | 1.381 | −40.37% | −4.675 |
| 2.1/2.1 acoustic PVB vs. 0.7/0.7/0.7 0.76 AC-PVB | 2.316 | 1.379 | −40.46% | −4.685 |

Notwithstanding the improved sound attenuation shown for the multi-transparency laminate, Table 1 shows that the weight of the laminate of Line 5 in FIG. 3 is only 7.18% greater per unit weight than the weight of the two-transparency laminate of Line 3. Further, Table 1 also shows that the weight of the laminate of Line 4 in FIG. 3 actually is 6.08% less per unit weight than the weight of the two-transparency laminate of Line 3.

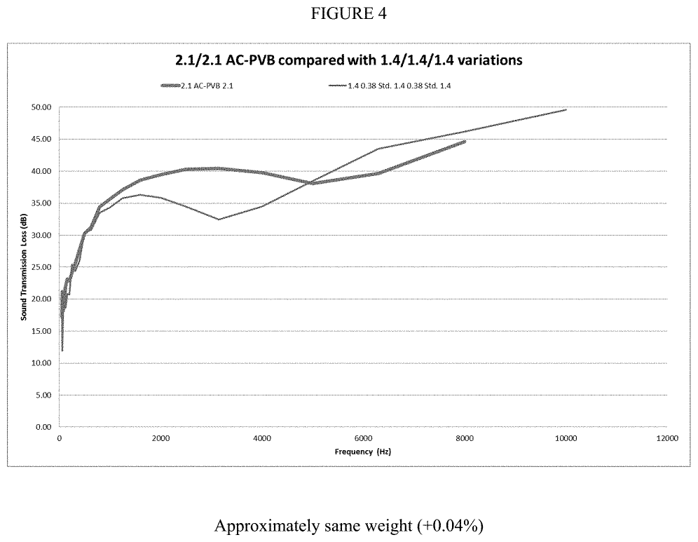

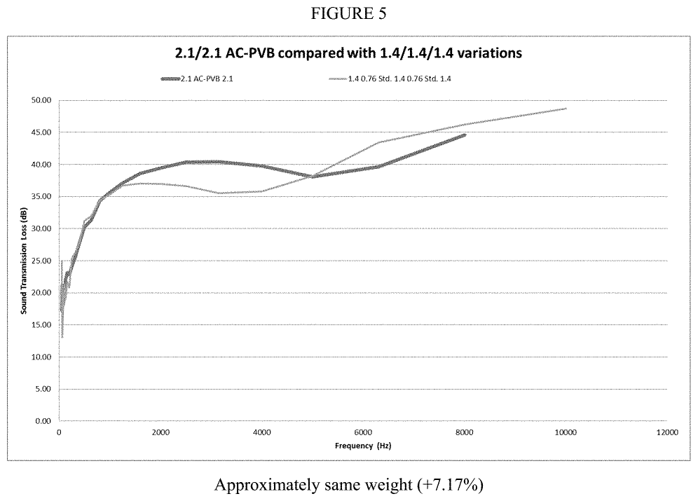

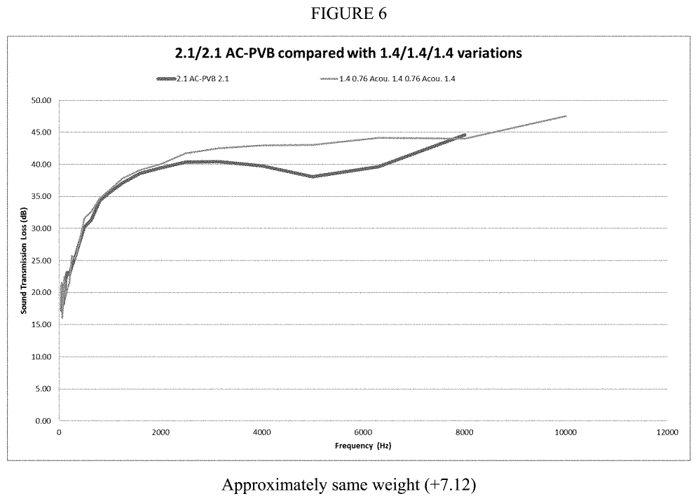

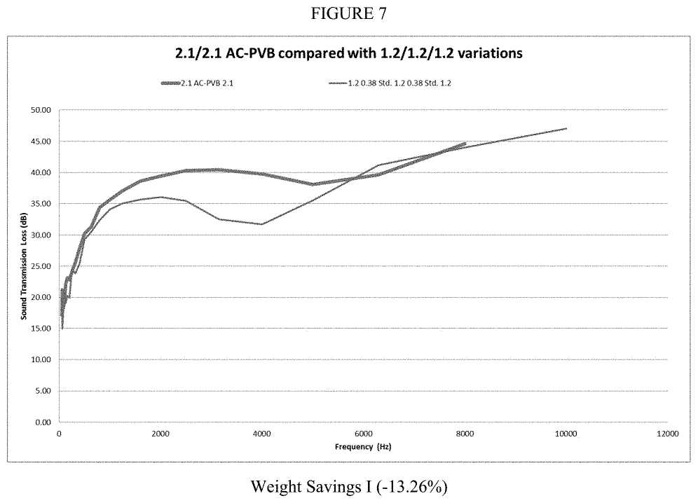

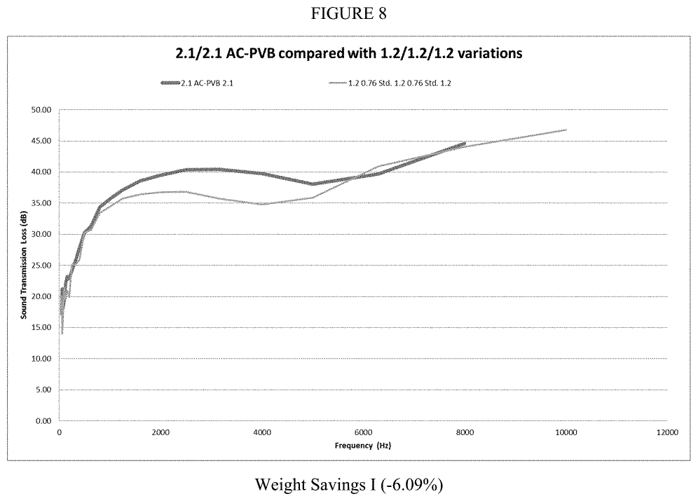

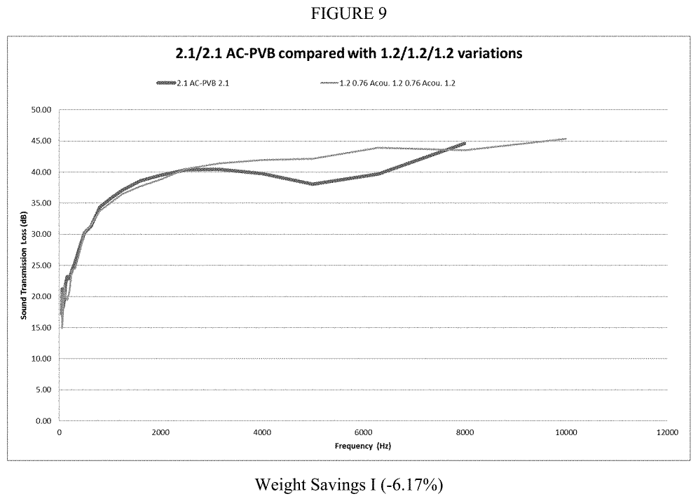

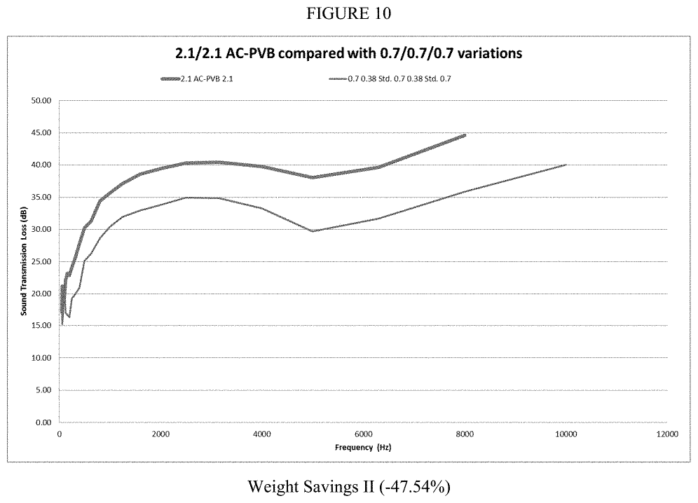

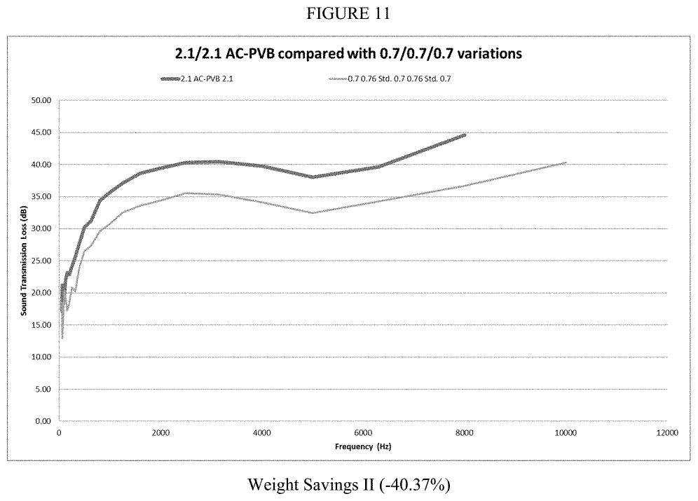

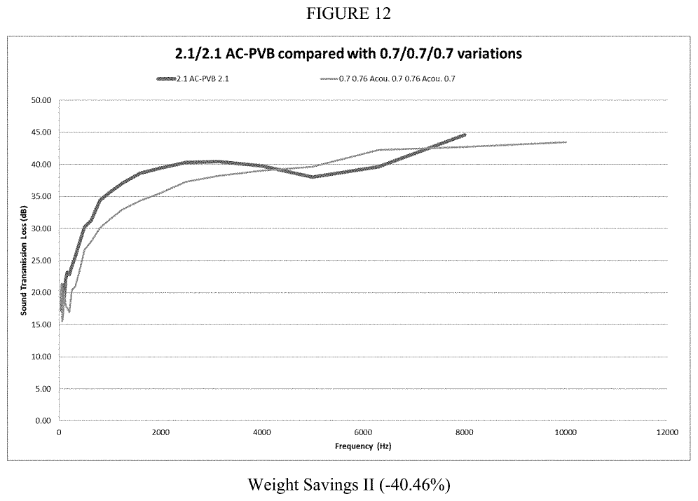

Other examples of weight comparisons between two-transparency laminates and multi-transparency laminates are detailed in the following FIGS. 4-12.

The forgoing multi-transparency laminates with transparencies of the same nominal thickness are symmetric glazings that may be preferred in vehicle applications for non-forward looking glazings. In applications for forward-looking vehicle glazings such as windshields, asymmetric glazings may be preferred. In asymmetric multi-transparency applications, the transparency that is oriented on the external surface of the vehicle is thicker than the other transparencies. Asymmetric multi-transparencies may also have other applications for transparencies such as architectural windows and doors.

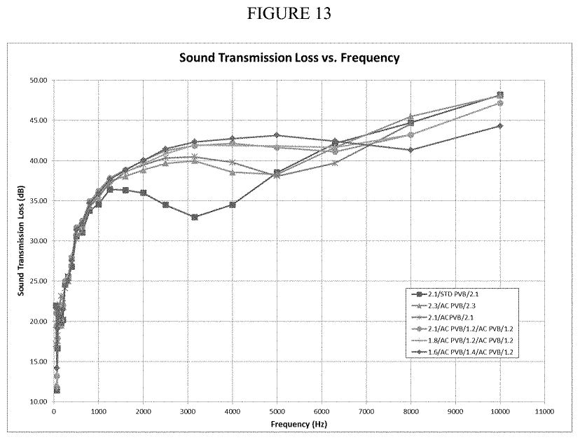

Sound attenuation characteristics of selected examples of such asymmetric multi-transparency glazings are illustrated in the line graph of FIG. 13.

FIG. 13 shows two-transparency glazings in lines 1, 2 and 3 and multi-transparency glazings in lines 4 and 5. Similar to the multi-transparency glazings of lines 4 and 5 in FIG. 3, the multi-transparency glazings of lines 4 and 5 in FIG. 13 demonstrate improved sound attenuation qualities as compared to two-transparency glazings particularly in the 1500-6500 Hz. range. However, FIG. 13 represents glazing constructions of the type that are typically used for forward looking glazings such as windshields. These constructions have greater chip impact resistance than glazings of the type wherein the transparencies have the same thickness. In FIG. 13, line 1 represents a glazing with two transparencies of 2.1 mm thickness that are bonded by a layer of standard PVB into a laminate. Line 2 represents a glazing with two transparencies of 2.3 mm thickness that are bonded by a layer of acoustic PVB. Line 3 represents a glazing with two transparencies of 2.1 mm thickness that are bonded by a layer of acoustic PVB. The asymmetric multi-transparency laminates are represented in Lines 4 and 5. In the laminate of Line 4, the outermost transparency (as oriented in the vehicle) has a 2.1 mm thickness and two additional transparencies that are arranged toward the interior of the vehicle, each have a respective thickness of 1.2 mm. Each of the transparencies are bonded to the adjacent transparency by a layer of acoustic PVB. Similar to the glazing of Line 4, in the laminate of Line 5 the outermost transparency (as oriented in the vehicle) has a 1.8 mm thickness and two other transparencies that are arranged toward the interior of the vehicle have a respective thickness of 1.2 mm each. Each of the transparencies are bonded to the adjacent transparency by a layer of acoustic PVB. The asymmetric multi-transparency laminates of Lines 4 and 5 in FIG. 13 demonstrates improved sound attenuation of about 4 dB in the 4,000-5,000 Hz. range in comparison to the laminates of Lines 1, 2 and 3 in FIG. 13. In comparison to the symmetric two-transparency laminate of line 1, the asymmetric multi-transparency glazing of Lines 4 and 5 demonstrate improved sound attenuation at 3,150 Hz. of about 9 dB and an improved sound attenuation at 4,000 Hz. of about 7.5 dB.

Like symmetric multi-transparency laminate glazings, asymmetric multi-transparency laminate glazings such as herein disclosed do not have such a coincidence dip and effectively eliminate the problem of the coincidence dip as experienced in the prior art.

In some cases, asymmetric multi-transparency glazings have been found to accentuate improvements in sound attenuation with respect to symmetrical two-transparency glazings over specified frequency ranges. An example of such an asymmetric multi-transparency glazing is shown in Line 6 of FIG. 13. The asymmetrical multi-transparency glazing of Line 6 is composed of an outermost (as oriented on the vehicle) transparency of 1.6 mm thickness, a center transparency of 1.4 mm thickness, and an innermost (as oriented on the vehicle) transparency of 1.2 mm thickness. The transparencies are bonded together in a laminate stack by two layers of acoustic PVB. One layer of acoustic PVB is located between the outermost and center transparencies and the other layer of acoustic PVB is located between the center and innermost transparencies. As shown in FIG. 13, the Line 6 glazing affords still further improvements in sound attenuation of about 1.3 dB in the frequency range of about 5,000-6,000 Hz. This is useful in selectively focusing additional sound attenuation in that range, but may be limited in certain applications because the sound attenuation performance is somewhat less in the frequency range of 6,300-10,000 Hz.

The forgoing Figures illustrate that the presently disclosed symmetric and asymmetric multi-transparency laminate glazings afford comparable or greater sound attenuation properties than two-transparency laminate glazings without compromising the glazing with a material increase in per unit weight. In some cases, the per unit weight is actually lower. In particular, prior art laminate glazings exhibit a coincidence dip in sound attenuation over the range of 3,000 to 8,000 Hz. The symmetric and asymmetric multi-transparency laminated glazings that are disclosed herein effectively eliminate the 3,000 to 8,000 Hz. coincidence dip without a penalty of additional weight and, in some cases, with even a weight reduction.

In addition to advantageous sound attenuation properties, the asymmetric multi-transparency laminates of lines 4 and 5 in FIG. 13 also potentially have improved stone impact resistance. In addition, thicker outer transparencies also have been found to afford improved chip impact resistance.

Referring to the accompanying drawings, the presently disclosed symmetric and asymmetric multi-transparency laminate glazings include three or more transparency layers that are bonded together in a laminate by a viscoelastic layer between each of the adjacent transparencies. The viscoelastic interlayers may be PVB or other material that suitably dissipate vibration energy from sound waves from one of the adjacent transparencies into shear forces that generate heat. The disclosed multi-transparency laminate glazings include two or more such viscoelastic layers for dissipating mechanical energy from sound vibrations into heat energy in the viscoelastic layers. Such construction affords two or more stages of damping for attenuating sound transmission through the multi-transparency laminate glazing.

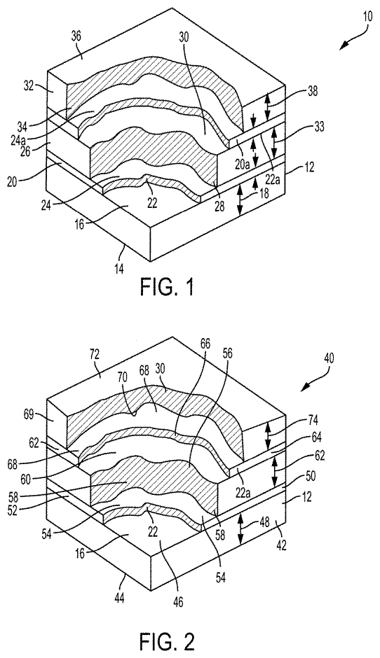

FIG. 1 shows a symmetric multi-transparency laminate glazing 10 as disclosed herein. Symmetric multi-transparency laminate glazing 10 includes an outer transparency sheet 12 that defines a first surface 14 and a second surface 16 that is oppositely disposed on sheet 12 from first surface 14. First surface 14 and second surface 16 are separated from each other by a thickness dimension 18 that is oriented orthogonally to each of first surface 14 and second surface 16.

Symmetric multi-transparency laminate glazing 10 further includes an interlayer 20 that defines a layer of polymer material having a first surface 22 and a second surface 24 that is oppositely disposed on said polymer layer from first surface 22. The first surface 22 of interlayer 20 is opposed to the second surface 16 of outer transparency sheet 12.

Symmetric glazing 10 further includes an intermediate transparency sheet 26 that defines a first surface 28 and a second surface 30 that is oppositely disposed on sheet 26 from first surface 28. First surface 28 and second surface 30 are separated from each other by a thickness dimension 33 that is oriented orthogonally to each of first surface 28 and second surface 30.

Symmetric multi-transparency laminate glazing 10 further includes a second interlayer 20a that defines a layer of polymer material having a first surface 22a and a second surface 24a that is oppositely disposed on said polymer layer from first surface 22a. The first surface 22a of interlayer 20a is opposed to the second surface 30 of intermediate transparency sheet 26.

Symmetric glazing 10 further includes an inner transparency sheet 32 that defines a first surface 34 and a second surface 36 that is oppositely disposed on sheet 32 from first surface 34. First surface 34 and second surface 36 are separated from each other by a thickness dimension 38 that is oriented orthogonally to each of first surface 34 and second surface 36. Symmetrical glazing 10 is “symmetrical” in that nominal thicknesses 18, 33 and 38 of respective transparencies 12, 26 and 32 are the same.

FIG. 2 shows the top perspective view of an asymmetric glazing laminate 40. Much of the structure of asymmetric glazing laminate 40 is similar to the structure of symmetric glazing laminate 10, but there are also important differences.

As shown in FIG. 2, asymmetric glazing 40 includes an outer transparency sheet 42 that defines a first surface 44 and a second surface 46 that is oppositely disposed on sheet 36 from first surface 38. First surface 44 and second surface 46 are separated from each other by a thickness dimension 48 that is oriented orthogonally to each of first surface 44 and second surface 46.

Asymmetric glazing 40 further includes an interlayer 50 that defines a layer of polymer material having a first surface 52 and a second surface 54 that is oppositely disposed on said polymer layer from first surface 52. First surface 52 of interlayer 50 is opposed to the second surface of 46 of outer transparency sheet 42.

Asymmetric glazing 40 further includes an intermediate transparency sheet 56 that defines a first surface 58 and a second surface 60 that is oppositely disposed on sheet 56 from first surface 58. First surface 58 and second surface 60 are separated from each other by a thickness dimension 62 that is oriented orthogonally to each of first surface 58 and second surface 60

Asymmetric glazing 40 further includes a second interlayer 64 that defines a layer of polymer material having a first surface 66 and a second surface 68 that is oppositely disposed on said polymer layer from first surface 66. First surface 66 of interlayer 64 is opposed to the second surface 60 of intermediate transparency sheet 56.

Asymmetric glazing 40 further includes an inner transparency sheet 69 that defines a first surface 70 and a second surface 72 that is oppositely disposed on sheet 69 from first surface 70. First surface 70 and second surface 72 are separated from each other by a thickness dimension 74 that is oriented orthogonally to each of first surface 70 and second surface 72.

Asymmetric glazing 40 is “asymmetrical” in that thickness 48 of outer transparency 42 is greater than the thickness 62 of intermediate transparency 58 and also greater than the thickness of inner transparency 69. In the example of the embodiment of FIG. 2, the asymmetric multi-transparency laminate glazing has an intermediate transparency and an inner transparency with the same thickness dimensions. However, the disclosed asymmetrical multi-transparency laminate glazings are not limited to structures wherein the intermediate transparency and the inner transparency have the same thickness dimensions. Intermediate transparencies and inner transparencies with different thickness dimensions also can be used.

As also mentioned earlier, the multi-transparency laminate glazings disclosed herein are not limited to glazings with three transparencies and two interlayers. Other multiples of transparencies and interlayers also can be used.

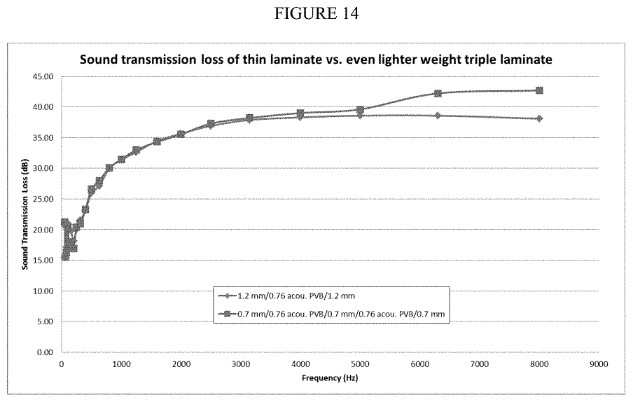

In some embodiments of the multi-transparency laminate glazings, it has been found that they afford sound attenuation performance that is superior to two-transparency laminate glazings and also have lower per unit weight. This may be true even in cases where the two-transparency laminate itself is designed for reduced weight in comparison to standard two-transparency glazings. FIG. 14 below displays the sound attenuation of a symmetrical multi-transparency glazing such as shown in FIG. 1 in comparison to a two-transparency glazing.

In prior art two-transparency glazings, both transparencies typically have a thickness of 2.1 mm. However, some two-transparency glazings that are designed for lower weight have been constructed with both transparencies having a thickness of 1.2 mm and an interlayer of acoustic PVB of 0.76 mm thickness. The per unit weight for glazings of that symmetrical lightweight construction is 1.392 lbs./sq. ft.—lower than the per unit weight of the typical two-transparency glazing with 2.1 mm transparencies. However, a multi-transparency glazing of the construction shown in FIG. 1 with all three transparencies having a thickness of 0.7 mm and two interlayers of acoustic PVB of 0.76 mm has a per unit weight of 1.379 lbs./sq. ft.—less than the two-transparency lightweight glazing with 1.2 mm transparencies. In the case of this example, as shown by the improved sound attenuation of the multi-transparency glazings, and other similar cases with multi-transparency glazings, the glazing acoustic performance can be improved with nearly similar weight per unit area using multi-transparency glazings.

FIG. 14 shows sound attenuation of both glazings as a function of frequency. The multi-transparency glazing illustrates better attenuation at frequencies of above about 4,000 Hz.

The interlayers of symmetric glazing 10 and the interlayers of asymmetric glazing 40 may be a polymer material such as ethylene vinyl acetate, polyvinyl butyral, polyethane, polycarbonate, polyethylene terephthalates, and combinations thereof. The interlayers bond oppositely facing transparency sheets in accordance with autoclave processes that are known in the art. Following the autoclave process, the thickness of acoustic PVB may be in the range of 0.38 mm to 1.52 mm and, more specifically, the thickness of acoustic PVB may be in the range of 0.71 mm to 0.81 mm. Human auditory recognition normally occurs for sounds in the range of about 20 Hz to about 20,000 Hz, but humans are generally most sensitive to sound in the range of about 1,000 Hz to about 6,000 Hz. The “coincidence dip”, as can be seen in FIG. 1, Line 2, is due to the vibration frequency of the transparency matching the vibration frequency of the incident sound pressure waves. Frequencies that produce coincidence conditions in the glazing may be generally referred to as “coincidence frequencies”. At certain coincidence frequencies, sound waves that impact the outer transparency cause a glazing to vibrate and enhance sound transmission from the glazing to the passenger compartment. Accordingly, sound attenuation is enhanced by damping coincidence frequencies, particularly frequencies in the 1,000 Hz to 6,000 Hz range where humans have higher sensitivity. Utilizing multi-transparency glazings to effectively accomplish sound attenuation in the coincidence frequencies as more specifically explained herein. Namely, improvements in the damping performance of multi-laminate glazings as compared to other glazings is shown and described in connection with the various Graphs and Tables herein disclosed. In accordance with the improvements herein disclosed, disclosed multi-transparency glazings having assembly configurations and thicknesses of transparencies and interlayer polymers achieve improved acoustical performance while maintaining approximately the same, or even lower weight in comparison to glazings known in the prior art.

We claim:

1. A symmetric glazing laminate having two or more stages for attenuating sound transmission, said symmetric glazing laminate having at least three transparency plies that have the same nominal thickness, said symmetric glazing laminate comprising:
a first transparency ply that defines a first surface and that defines a second surface that is oppositely disposed on said first transparency ply from said first surface, said first surface and said second surface of said first transparency ply being separated by a thickness dimension that is oriented orthogonally to each of said first surface and said second surface of said first transparency;
a second transparency ply that defines a first surface and that defines a second surface that is oppositely disposed on said second transparency ply from said first surface, said first surface and said second surface of said second transparency ply being separated by a thickness dimension that is oriented orthogonally to each of said first surface and said second surface of said second transparency ply;
a first interlayer of viscoelastic material that is capable of dissipating mechanical energy from sound vibrations into heat energy, said first interlayer defining a first surface and a second surface that is oppositely disposed on said first interlayer from said first surface, the first surface of said first interlayer opposing the second surface of said first transparency ply and the second surface of said first interlayer opposing the first surface of said second transparency ply, said first surface of said first interlayer and said second surface of said first interlayer being separated by a thickness dimension that is oriented orthogonally to each of said first surface and said second surface of said first interlayer;
a third transparency ply that defines a first surface and that defines a second surface that is oppositely disposed on said third transparency ply from said first surface, said first surface and said second surface of said third transparency ply being separated by a thickness dimension that is oriented orthogonally to each of said first surface and said second surface of said third transparency ply; and
a second interlayer of viscoelastic material that is capable of dissipating mechanical energy from sound vibrations into heat energy, said second interlayer defining a first surface and a second surface that is oppositely disposed on said second interlayer from said first surface, the first surface of said second interlayer opposing the second surface of said second transparency ply and the second surface of said second interlayer opposing the first surface of said third transparency ply, said first surface of said second interlayer and said second surface of said second interlayer being separated by a thickness dimension that is oriented orthogonally to each of said first surface and said second surface of said second interlayer, such that said first interlayer and said second interlayer dampen vibrations in said symmetric glazing laminate caused by sound pressure waves that impact said first transparency ply.

2. The symmetric glazing of claim 1 wherein the sound transmission loss in the glazing over the frequency range of 1,500 to 5,000 Hz is greater than the sound transmission loss of a two-ply symmetric glazing having a per unit weight that is greater than the per unit weight of said symmetric glazing.

3. The symmetric glazing of claim 2 wherein said first transparency ply and said second transparency ply and said third transparency ply each have a nominal thickness that is equal to or less than 1.4 millimeters.

4. The symmetric glazing of claim 2 wherein said first transparency ply and said second transparency ply and said third transparency ply each have a nominal thickness that is equal to or less than 1.2 millimeters.

5. The symmetric glazing of claim 2 wherein said first transparency ply and said second transparency ply and said third transparency ply each have a nominal thickness that is equal to or less than 0.7 millimeters.

6. The symmetric glazing of claim 1 wherein said viscoelastic material of said first interlayer and the viscoelastic material of said second interlayer is a polymer material.

7. The symmetric glazing of claim 6 wherein said viscoelastic material of said first interlayer and the viscoelastic material of said second interlayer is selected from the group comprising ethylene vinyl acetate, polyvinyl butyral, polyethane, polycarbonate, polyethylene terephthalates, and combinations thereof.

8. The symmetric glazing of claim 1 wherein said first interlayer and said second interlayer are comprised of acoustic PVB.

9. The symmetric glazing of claim 2 wherein said first interlayer and said second interlayer each have a nominal thickness that is in the range of 0.38 mm to 1.52 mm.

10. The symmetric glazing of claim 2 wherein said first interlayer and said second interlayer each have a nominal thickness that is in the range of 0.71 mm to 0.81 mm.

11. The symmetric glazing of claim 2 wherein said first interlayer and said second interlayer each have a nominal thickness that is not greater than 0.76 millimeters.

12. The symmetric glazing of claim 2 wherein said symmetric glazing has a per unit weight of 1.379 lbs./sq. ft.

13. An asymmetric glazing laminate having two or more stages for attenuating sound transmission, said symmetric glazing laminate having at least three transparency plies, said symmetric glazing laminate comprising:
a first transparency ply that defines a first surface and that defines a second surface that is oppositely disposed on said first transparency ply from said first surface, said first surface and said second surface of said first transparency ply being separated by a thickness dimension that is oriented orthogonally to each of said first surface and said second surface of said first transparency;
a second transparency ply that defines a first surface and that defines a second surface that is oppositely disposed on said second transparency ply from said first surface, said first surface and said second surface of said second transparency ply being separated by a thickness dimension that is oriented orthogonally to each of said first surface and said second surface of said second transparency ply;
a first interlayer of viscoelastic material that is capable of dissipating mechanical energy from sound vibrations into heat energy, said first interlayer defining a first surface and a second surface that is oppositely disposed on said first interlayer from said first surface, the first surface of said first interlayer opposing the second surface of said first transparency ply and the second surface of said first interlayer opposing the first surface of said second transparency ply, said first surface of said first interlayer and said second surface of said first interlayer being separated by a thickness dimension that is oriented orthogonally to each of said first surface and said second surface of said first interlayer;
a third transparency ply that defines a first surface and that defines a second surface that is oppositely disposed on said third transparency ply from said first surface, said first surface and said second surface of said third transparency ply being separated by a thickness dimension that is oriented orthogonally to each of said first surface and said second surface of said third transparency ply, wherein the nominal thickness of said first transparency ply is greater than the nominal thickness of said second transparency ply and also greater than the nominal thickness of said third transparency ply; and
a second interlayer of viscoelastic material that is capable of dissipating mechanical energy from sound vibrations into heat energy, said second interlayer defining a first surface and a second surface that is oppositely disposed on said second interlayer from said first surface, the first surface of said second interlayer opposing the second surface of said second transparency ply and the second surface of said second interlayer opposing the first surface of said third transparency ply, said first surface of said second interlayer and said second surface of said second interlayer being separated by a thickness dimension that is oriented orthogonally to each of said first surface and said second surface of said second interlayer, such that said first interlayer and said second interlayer dampen vibrations in said symmetric glazing laminate caused by sound pressure waves that impact said first transparency ply.

14. The asymmetric glazing of claim 13 wherein the sound transmission loss in the glazing over the frequency range of 1,500 to 5,000 Hz is greater than the sound transmission loss of a two-ply symmetric glazing having a per unit weight that is greater than the per unit weight of said asymmetric glazing.

15. The asymmetric glazing of claim 14 wherein the nominal thickness of said first transparency ply is 2.1 mm and wherein the nominal thickness of said second transparency ply and said third transparency ply each have a nominal thickness that is equal to or less than 1.2 millimeters.

16. The asymmetric glazing of claim 14 wherein the nominal thickness of said first transparency ply is 1.8 mm and wherein the nominal thickness of said second transparency ply and said third transparency ply each have a nominal thickness that is equal to or less than 1.2 millimeters.

17. The asymmetric glazing of claim 14 wherein the nominal thickness of said first transparency ply is 1.6 mm and wherein the nominal thickness of said second transparency ply is 1.4 mm and wherein the nominal thickness of said third transparency ply is 1.2 mm.

18. The asymmetric glazing of claim 13 wherein said viscoelastic material of said first interlayer and the viscoelastic material of said second interlayer is a polymer material.

19. The asymmetric glazing of claim 13 wherein said viscoelastic material of said first interlayer and the viscoelastic material of said second interlayer is selected from the group comprising ethylene vinyl acetate, polyvinyl butyral, polyethane, polycarbonate, polyethylene terephthalates, and combinations thereof.

20. The asymmetric glazing of claim 13 wherein said first interlayer and said second interlayer are comprised of acoustic PVB.

21. The asymmetric glazing of claim 14 wherein said first interlayer and said second interlayer each have a nominal thickness that is in the range of 0.38 mm to 1.52 mm.

22. The asymmetric glazing of claim 14 wherein said first interlayer and said second interlayer each have a nominal thickness that is in the range of 0.71 mm to 0.81 mm.

23. The asymmetric glazing of claim 14 wherein said first interlayer and said second interlayer each have a nominal thickness that is not greater than 0.76 millimeters.

24. The asymmetric glazing of claim 14 wherein said symmetric glazing has a per unit weight of 1.379 lbs./sq. ft.
